(19) United States
(12) Patent Application Publication
(10) Pub. No.: US 2018/0357711 A1
(43) Pub. Date: Dec. 13, 2018

(54) SYSTEM AND METHOD FOR CONDUCTING A REVERSE AUCTION FOR THE SALE AND PURCHASE OF AUTOMOBILES

(71) Applicant: Christopher C. Konawel, Woodbury Heights, NJ (US)

(72) Inventor: Christopher C. Konawel, Woodbury Heights, NJ (US)

(21) Appl. No.: 15/629,005

(22) Filed: Jun. 21, 2017

Related U.S. Application Data
(60) Provisional application No. 62/353,115, filed on Jun. 22, 2016.

(51) Int. Cl. G06Q 30/08; G06Q 30/06

(52) U.S. Cl. CPC G06Q 30/08; G06Q 30/0601; G06Q 30/0629

(57) ABSTRACT

A system and method for the purchase of an automobile by a prospective purchaser by accessing prospective seller through a network of competing automobile dealerships.

### CROSS REFERENCE TO RELATED APPLICATION

This application claims the benefit of U.S. Provisional Application No. 62/353,115 filed on Jun. 22, 2016.

### FIELD OF THE INVENTION

The present invention relates in general to the sale and purchase of automobiles.

### BACKGROUND

Currently, prospective car buyers and car dealers face challenges in the car purchasing process. A prospective buyer is inundated with a number of advertisements for vehicles when they are often looking for a particular make and model for a given vehicle. Great effort must be exerted to first identify a reputable car dealer and then further effort must be employed to determine whether a vehicle conforming to the buyer's needs can be found in the dealer's inventory.

Price negotiations often occur after a prospective buyer invests time and effort with test drives and on-site discussions with sales representatives. These steps consume time for the dealership as well. Often, the time is wasted if the consumer ultimately cannot reach an accord on pricing or elects purchase a vehicle from a competing dealership. A need, therefore, exists in the art to reduce the transaction costs faced by dealers in the car purchase process while at the same time advancing a prospective buyer's objective for obtaining the highest quality automobile for the lost cost.

### SUMMARY OF THE INVENTION

The present invention is a system and method for a computer-implemented auction for the purchase of an automobile. The system preferably comprises a client-server computer network that is programmed to allow a user/prospective purchaser to input car specifications into one or more databases found on a computer system linked on a network with a plurality of server and user computers. Both users/prospective purchasers and car dealerships utilize such network linked computers so as to permit their shared use of the database. The user car specifications comprise, in the preferred embodiment, the car make, model, and year. Optionally, a user may specify other characteristics, such as a range of years, a plurality of makes and models, color, and mileage, for example.

Those car dealers who are in the network are notified when a user inputs specifications into the database. at step 10. One or more of those car dealers may then access the system of the instant invention and view user input from the said database related to the desired automobile specifications provided by the user. Car dealerships may then review their inventory of automobiles in order to determine whether or not they have a vehicle with specifications matching those requested by the user. In the case in which one or more of these local car dealers has or have inventory matching the user's specifications, the local car dealer can upload matching vehicle specifications to the database and the user receives a notice that such a response has been made which includes a purchase price offered by the dealer. In the case in which more than one car dealer provides responses to the user's request, the local car dealers have the option of adjusting their offering prices utilizing the system of the instant invention to compete against one another. The user may then utilize the system of the instant invention to correspond directly with the responding car dealerships.

### BRIEF DESCRIPTION OF THE DRAWINGS

The invention will become more readily apparent from the following description of preferred embodiments thereof shown, by way of example only, in the accompanying drawings wherein:

FIG. 1 is a flow chart that describes the method of the present invention.

### DETAILED DESCRIPTION OF THE INVENTION

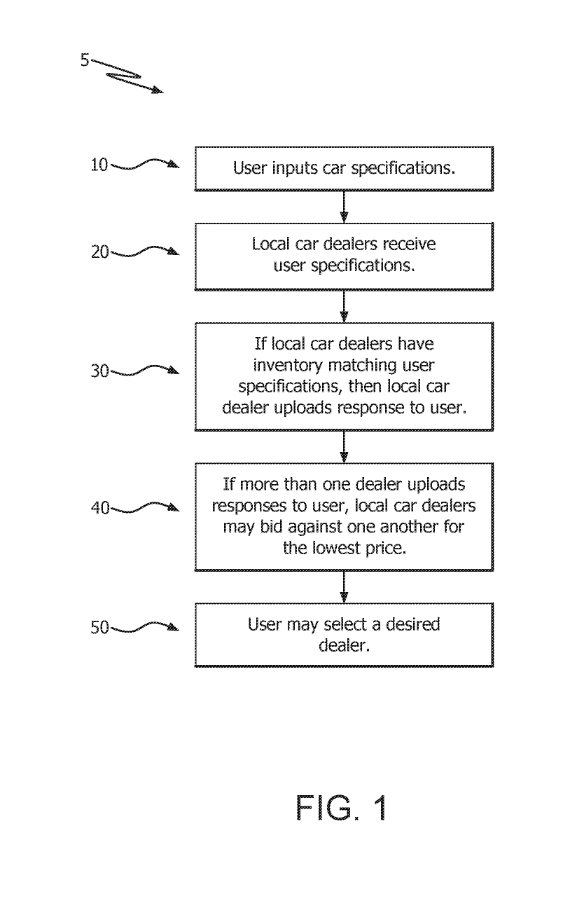

The system preferably comprises a client-server computer network, as is well known in the art, and as further described herein. FIG. 1 depicts a flowchart, generally identified by reference numeral 5, illustrating a preferred embodiment of the instant invention. At step 10, a user inputs car specifications into one or more databases found on a computer system linked on a network with a plurality of server and user computers. Both users and car dealerships utilize such network linked computers so as to permit their shared use of the database(s). The user car specifications comprise, in the preferred embodiment, the car make, model, and year. Optionally, a user may specify other characteristics, such as a range of years, a plurality of makes and models, color, and mileage, for example.

At step 20, one or more local car dealers are notified when a user inputs specifications into the database at step 10. In the preferred embodiment, the car dealers are notified by e-mail or text messages. The car dealer may then access the system of the instant invention and view user input from the said database related to the desired automobile specifications provided by the user. Car dealerships may then review their inventory of automobiles in order to determine whether or not they have a vehicle with specifications matching those requested by the user. In another embodiment, the database is integrated with the car dealership's inventory computer systems to automate the process of determining whether matching inventory exists.

At step 30, if the local car dealer has inventory matching the user's specifications, the local car dealer can upload matching vehicle specifications to the database and the user receives a notice that such a response has been made. In the preferred embodiment, the user is notified by e-mail or text messages. The local car dealer's matching vehicle specifications comprise the vehicle's offering price, make, model, and mileage. In a preferred embodiment, participating car dealers have a record of feedback from prior users that is visible to the car dealer and the users. In the preferred embodiment, the dealer's distance from the user is also provided to the user. A car dealer may also elect to provide information about the vehicle's color, condition, warranty options and other relevant information. Photos of the vehicle may also be uploaded to the system of the instant invention for review by the user.

In step 40, if more than one car dealer provides responses to the user's request, the local car dealers have the option of adjusting their offering prices utilizing the system of the instant invention to compete against one another. In a preferred embodiment, the lowest four matching bids are presented to the user. The user may then utilize the system of the instant invention to correspond directly with the car dealerships. In a preferred embodiment, this is accomplished through e-mail or an online chat function.

The user may then arrange to inspect the vehicle of his or her choice based on the user's consideration of the variables that have been presented through the system of the instant invention. The communication features described herein may be further utilized to permit the users to arrange a time and date to view and test drive the vehicle, as illustrated at step 50. In a preferred embodiment, the car dealers are only provided with personally identifiable information about the user once the user elects to supply this information. After the transaction is finalized, the user is given the opportunity to provide feedback about the experience with a particular car dealer so as to populate the database of the instant invention with additional information which can be visible to other users in future transactions in the manner herein described.

Although the invention has been described in terms of exemplary embodiments, it is not limited thereto. Rather, the instant invention should be construed broadly to include other variants and embodiments of the invention which may be made by those having ordinary skill in the art.

What is claimed is:

1. A method for a user to initiate and complete a transaction for an automobile comprising the steps of:
providing a means for a user to promulgate said user's preferences for an automobile to a panoply of potential local automobile dealers;
providing a means for said dealers to review and respond to said user;
alerting responding dealers in the case that more than one such response has been made;
allowing each of said responding dealers to modify said response in such case;
providing said modified responses to said user; and
allowing said user to select a responding dealer to complete a transaction for said automobile in accordance with said selected response.

2. The method of claim 1 in which said means is a panoply of computers connected to a network.

3. The method of claim 2 in which said computers are selected from a group comprising: servers, desktop computers, laptop computers, tablets, and smartphones.

4. The method of claim 3 in which said transaction is selected from a group comprising: sales transactions and lease transactions.

5. The method of claim 4 in which one of said preferences is selected from a group comprising: new automobiles and used automobiles.

6. The method of claim 5 in which said preferences also include at least one preference selected from a group of automobile characteristics comprising: price, make, model, year, color, style, and options.

7. A system for the initiation and completion of a transaction for an automobile comprising a panoply of computers connected to a network by which a user having access to one of said computers promulgates said user's preferences for an automobile to a panoply of potential local automobile dealers, each having access to one of said computers, whereby said computers provide a means for said dealers to review and respond to said user, said responding dealers are alerted in the case that more than one such response has been made, said dealers being allowed to modify said responses in such case, said modified responses being provided to said user, and said user being allowed to select a responding dealer to complete a transaction for said automobile in accordance with said selected response.

8. The system of claim 7 in which said computers are selected from a group comprising: servers, desktop computers, laptop computers, tablets, and smartphones.

9. The system of claim 8 in which said transaction is selected from a group comprising: sales transactions and lease transactions.

10. The system of claim 9 in which one of said preferences is selected from a group comprising: new automobiles and used automobiles.

11. The system of claim 10 in which said preferences also include at least one preference selected from a group of automobile characteristics comprising: price, make, model, year, color, style, and options.
